(19) United States
(12) Patent Application Publication
(10) Pub. No.: US 2020/0251767 A1
(43) Pub. Date: Aug. 6, 2020

(54) Mechanical Interfacial Control of Lithium Metal Anodes

(71) Applicant: National Technology & Engineering Solutions of Sandia, LLC, Albuquerque, NM (US)

(72) Inventors: Katharine Lee Harrison, Albuquerque, NM (US); Katherine Leigh Jungjohann, Sandia Park, NM (US); Brad L. Boyce, Albuquerque, NM (US)

(21) Appl. No.: 16/782,591

(22) Filed: Feb. 5, 2020

Related U.S. Application Data
(60) Provisional application No. 62/801,432, filed on Feb. 5, 2019.

(51) Int. Cl. H01M 10/04; H01M 10/0525; H01M 4/38; H01M 10/44

(52) U.S. Cl. CPC H01M 10/0468; H01M 10/0525; H01M 2004/027; H01M 10/44; H01M 4/382

(57) ABSTRACT

The contact pressure on the surface of the electrodes in lithium metal anodes can be used to control the electrodeposited lithium morphology and suppress lithium short circuiting in lithium ion batteries. For example, the contact pressure on the electrode surfaces can be controlled using a load frame in a pouch cell configuration, which allows constant force to be applied over a variety of contact pressures from 0-1 MPa. In a coin cell configuration, compression can be controlled using a wave spring, Belleville washer, or one or more pieces of metal foam. Higher pressures produce larger lithium grains and suppress dendrite formation. Although high contact pressure suppresses observable lithium dendrites, short circuiting can occur at the high contact pressures. Therefore, there is an optimal contact pressure for controlled electrodeposited lithium morphology.

### CROSS-REFERENCE TO RELATED APPLICATION

This application claims the benefit of U.S. Provisional Application No. 62/801,432, filed Feb. 5, 2019, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to lithium batteries and, in particular, to mechanical interfacial control of lithium metal anodes for lithium batteries.

### BACKGROUND OF THE INVENTION

Next-generation, high-energy-density lithium batteries (Li-metal, Li-sulfur, and Li air) require Li-metal anodes, which have 10× higher theoretical charge capacity relative to state-of-the-art graphite anodes and 2-5× higher projected pack-level energy density. Li-metal anodes have not been adopted commercially due to interfacial science challenges. Electrolyte instability at Li electrodeposition potentials results in a solid-electrolyte interphase (SEI) at the Li-electrolyte interface. An ideal SEI is thin, self-limiting, and protects the Li from further electrolyte reaction. Contrastingly, actual SEI films lead to: (1) uncontrolled morphology evolution (dendritic growth), which causes short circuits and fires; (2) Li consumption, which reduces cycle life and charge capacity; and (3) low charge/discharge rates due to the high impedance of the films.

### SUMMARY OF THE INVENTION

The present invention is directed to a method for controlling SEI formation in a lithium battery having a lithium metal anode, comprising applying interfacial compression to the lithium metal anode during electrochemical cycling. As an example, the lithium battery can comprise a pouch cell or a coin cell. To control SEI formation but not short the battery, the interfacial compression can be optimized for a contact pressure between 10 kPa and 1000 kPa.

The invention is further directed to a lithium ion coin cell battery comprising a lithium metal anode and a means for applying interfacial compression to the lithium metal anode during electrochemical cycling. The compression means can comprise a wave spring, Belleville washer, or metal foam.

The present invention enables the use of Li-metal anodes for high-energy-density, next-generation lithium batteries. Such batteries are of interest for portable electronics, electric vehicles, and grid storage.

### BRIEF DESCRIPTION OF THE DRAWINGS

The detailed description will refer to the following drawings, wherein like elements are referred to by like numbers.

FIGS. 1A and 1D are cyclic voltammograms of electrochemical cells with and without interfacial compression. FIGS. 1B, 1C, 1E, and 1F are scanning electron micrographs (SEMs) of deposited lithium films with (FIGS. 1B and 1C) and without compression (FIGS. 1E and 1F). See K. L. Harrison et al., ACS Nano 11, 11194 (2017).

FIG. 2A is a schematic illustration of SEI and Li films grown without interfacial compression. FIG. 2B is a schematic illustration of SEI and Li films grown with interfacial compression.

FIG. 3A is a schematic illustration of lithium ions and electrons moving through a lithium ion battery during charge. FIG. 3B is a schematic illustration of lithium ions and electrons moving through a lithium ion battery during discharge.

FIGS. 4A-4F are photographs of the pouch cell fabrication process. FIG. 4A shows depressions made in two pieces of plastic-coated aluminum. FIG. 4B shows the pouch opened to place the electrode stack. FIG. 4C shows the counter electrode spot welded to a nickel lead placed on the bottom of the stack. FIG. 4D shows the separator placed over the counter electrode. FIG. 4E shows the working electrode spot welded to a nickel lead placed on top of the separator. FIG. 4F shows the cell sealed across the nickel leads and then on the third side. After this step, electrolyte was injected with a pipet and the cell was sealed in a vacuum sealer on the final side. The nickel leads were prepared with an adhesive polymer tape which melts around the nickel to seal the leads in the pouch.

FIGS. 5A-5D show plots of coulombic efficiency versus cycle number for four cells (copper working electrode and lithium counter electrode) with different applied pressures: 0 kPa, 10 kPa, 100 kPa, and 1000 kPa, respectively. The current density applied was 4 mA/cm² and lithium was deposited to a capacity of 2 mAh/cm².

FIGS. 6A-6D show plots of voltage versus time for four cells (copper working electrode and lithium counter electrode) with four different applied pressures: 0 kPa, 10 kPa, 100 kPa, and 1000 kPa, respectively. The cell cutoff voltage was 1 V. The current density applied was 4 mA/cm² and lithium was deposited to a capacity of 2 mAh/cm².

FIGS. 7A-7F show SEM images of working and counter electrodes extracted from three pouch cells cycled to 0.5 cycles (after one lithium deposition and no stripping) at three different pressures: 10 kPa, 100 kPa, and 1000 kPa. The insets are SEM images of the lithium deposition on the working electrodes imaged at higher magnification.

FIG. 8 is a schematic illustration of the components that make up a typical coin cell. The wave spring can also be replaced by a Belleville washer or one or more pieces of Ni foam to provide compression that minimizes contact resistance.

FIG. 9A is a schematic showing the relevant dimensions of a Belleville washer. FIG. 9B is a graph of normalized force-deflection curves with varied height over thickness values.

FIG. 10 is a graph of force versus displacement for a wave spring typically used in 2032 coin cells. The force displacement response typically stabilizes after the first loading and unloading cycle.

FIG. 11′ is a graph of force versus displacement for a Belleville washer typically used in 2032 coin cells. The force displacement response typically stabilizes after the first loading and unloading cycle.

### DETAILED DESCRIPTION OF THE INVENTION

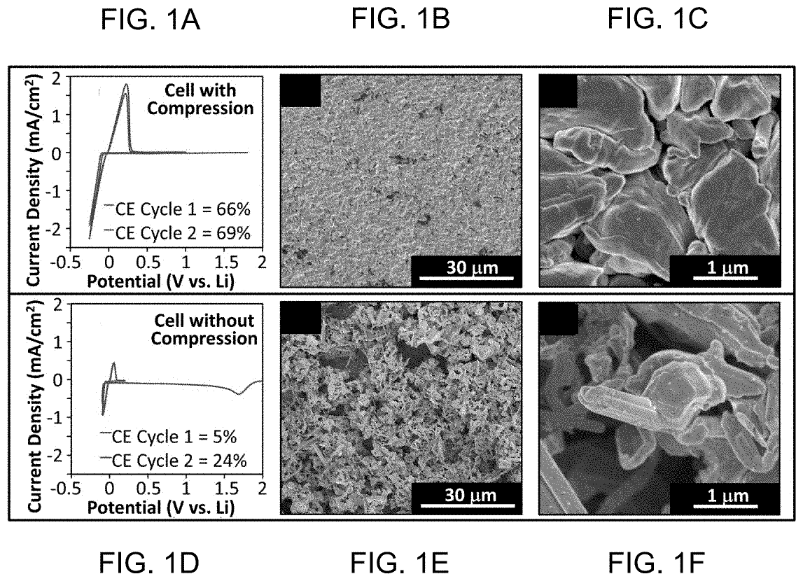

Because high-energy-density batteries require Li anodes, strategies to enable Li-metal anodes are actively researched. Similarly, SEI structure and composition have been studied widely. However, the effects of cell compression on SEI properties, Li electrodeposition, and the relationship between them have not been explored. A recent proof-of-principle study indicates that strategic engineering of stress at the Li-electrolyte interface during cycling is critical for controlling the Li morphology, Coulombic efficiency (CE), and limiting SEI formation. See K. L. Harrison et al., ACS Nano 11, 11194 (2017). FIGS. 1A-1F shows the results of experiments on a cell comprising a copper working electrode and a lithium counter electrode with Celgard 2400 separators between them in 4 M lithium bis(fluorosulfonyl)imide in 1,2-dimethoxyethane (LiFSI/DME) electrolyte with and without interfacial compression. Cyclic voltammetry (10 mV/s) results with compression are shown in FIG. 1A. Results without compression are shown in FIG. 1D. The reduction peak observed at 1.75 V was only observed without compression on the first cycle, evidence of SEI formation in this particular electrolyte system. CV measurements indicate much higher coulombic efficiency with compression than without. In separate experiments, SEM images were collected after one galvanostatic Li deposition cycle at 1 mA/cm² (capacity ˜1.5 C/cm²) with compression, as shown in FIGS. 1B and 1C, and without compression, as shown in FIGS. 1E and 1F. Dense, uniform and flat films are observed with compression, whereas mossy, high-aspect-ratio dendritic morphologies are observed without compression. From these experiments, it was concluded that compression is necessary to achieve high coulombic efficiency and favorable morphology in 4 M LiFSI/DME.

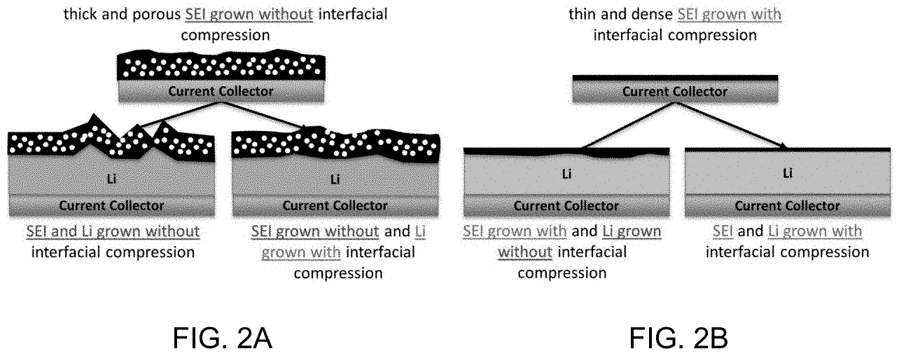

Therefore, SEI formation can play a major role in determining the relationship between compression and coulombic efficiency. As illustrated schematically in FIG. 2A, SEI forms readily and copiously and the Li morphology is not dense in the absence of interfacial compression. Copious SEI formation correlates with poor CE and dendritic Li morphology, leading to safety and performance problems. However, as depicted schematically in FIG. 2B, compression changes how the SEI forms, leading to a denser and more self-limiting SEI that controls the Li morphology and can more effectively protect the electrolyte from contact with the electrode.

### Electrochemical Cycling in Lithium Ion Batteries

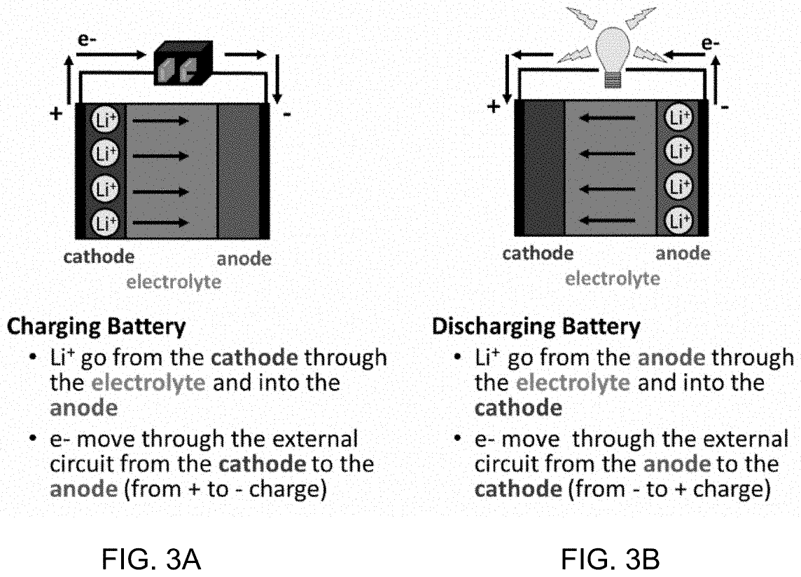

Charging and discharging of a lithium battery is illustrated in FIGS. 3A and 3B, respectively. Pouch cell batteries (sometimes called polymer cells) were fabricated to investigate electrochemical cycling with and without compression. Cycling is expected to change the lithium morphology relative to the first deposition step as compared to many cycles (over 100). These parameters were investigated at relative contact pressures from 0-1 MPa. The lithium morphology was characterized at each of these conditions.

### Pouch Cell Fabrication

Pouch cells comprise conductive foil-tabs that are welded to the electrodes of the electrochemical cell and brought to the outside in a fully sealed manner. To fabricate pouch cell batteries, current collectors were cut out of copper sheet metal and comprised 15 and 16 mm diameter circles connected to leads. The copper current collectors were acid treated to remove the oxide and generate a repeatable surface for lithium electrodeposition. See J. Qian et al., Nature communications 6 (2015). The current collectors were immersed in a 1 M hydrochloric acid solution for ten minutes and then rinsed thoroughly with deionized water and acetone. The current collectors were spot welded to Ni leads equipped with adhesive polymer tape in a dry room. The 15-mm diameter current collectors were used on the working electrode side of the cell and the 16 mm diameter current collectors were used on the counter electrode side of the cell. Lithium metal was rolled onto the counter electrode foil to act as a lithium source for plating and stripping on the working electrode. The current collectors were positioned carefully to ensure alignment between the counter and working electrodes and the leads were cut to proper length for the adhesive tape to melt at the edge of the assembled pouch cell.

The electrolyte used was 4 M lithium bis(fluorosulfonyl)imide in 1,2-dimethoxyethane (4 M LiFSI/DME). It was prepared according to previously documented procedures. See J. Qian et al., Nature communications 6 (2015); and K. L. Harrison et al., ACS Nano 11(11), 11194 (2017). The LiFSI salt was dried at 110 C overnight under vacuum in a glove box antechamber. Activated alumina was dried at 200 C under vacuum in a glove box antechamber for at least two days. DME was placed over the dried activated alumina (˜4:1 volume DME: activated alumina) for at least two days. The dry DME was extracted through a filter to remove any activated alumina floating in the DME. Then the DME and LiFSI were mixed in a 1.4:1 molar ratio (DME:LiFSI) to make a 4 M solution. The solution was stirred on a hot plate at 45 C overnight. Karl Fischer titration measurements revealed the water content was approximately 2 ppm.

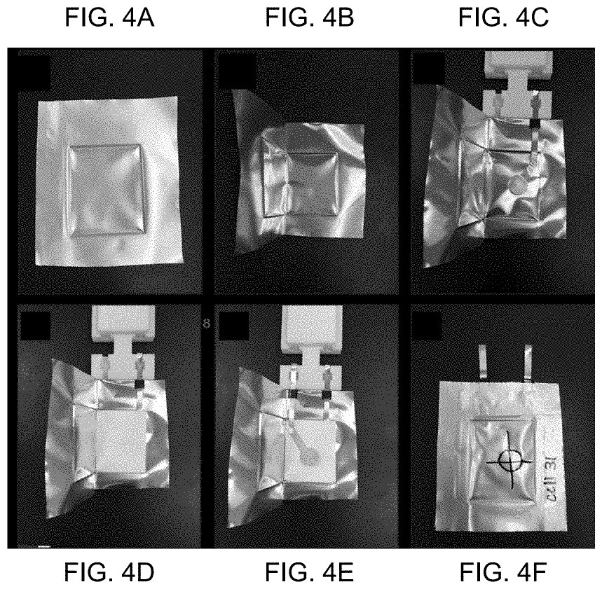

The process of assembling the pouch cells is shown in FIGS. 4A-4F. The pouch cells were assembled in a dry room. First, depressions are made in two sheets of polymer-coated aluminum and the sheets are stacked such that the top sheet nests within the bottom sheet. The sheets are heat sealed on one side. Then the counter electrode, which is spot welded to a Ni tab is placed in the depression. A separator material is placed on the counter electrode to prevent short circuits between the working electrode and the counter electrode. The pouch cell used two layers of Celgard 2325 separator, each layer consisting of a polyethylene sheet sandwiched between two polypropylene sheets. Then the working electrode is carefully aligned on top of the counter electrode. The pouch is closed and sealed across the Ni leads and then on the third side. At this point, the resistance across the leads is checked to ensure that the tabs and electrodes are electrically isolated from each other and the pouch walls. Then electrolyte (500 μL) is injected into the cell via micropipette and the pouch is placed in a vacuum sealer. This vacuum sealer removes the air from the pouch and seals the final side of the cell. All sides of the cell were sealed in two separate locations to ensure good seals.

### Pouch Cell Testing

The electrochemical pouch cell was compressed in a feedback-controlled load frame equipped with a load cell and strain gage. The pouches were compressed between two tungsten carbide compression platens. The pouch cells were compressed to 1.77, 177, or 1777 N, which corresponds to 10, 100, and 1000 kPa based on the area of the working electrodes. The specimens were loaded to the target force and held constant for a pre-determined length of time using feedback control software based on load cell and strain gauge measurements. The nickel leads coming out of the pouch cell were connected to a Gamry 1000E Potentiostat. The cells were cycled at a current of 4 mA/cm² to a capacity of 2 mAh/cm², corresponding to 30 minutes of current for deposition and stripping steps. Stripping was terminated when a cutoff voltage of 1 V was reached or 30 minutes had passed. In all tests, there was a one-minute open circuit potential step after each deposition and stripping step.

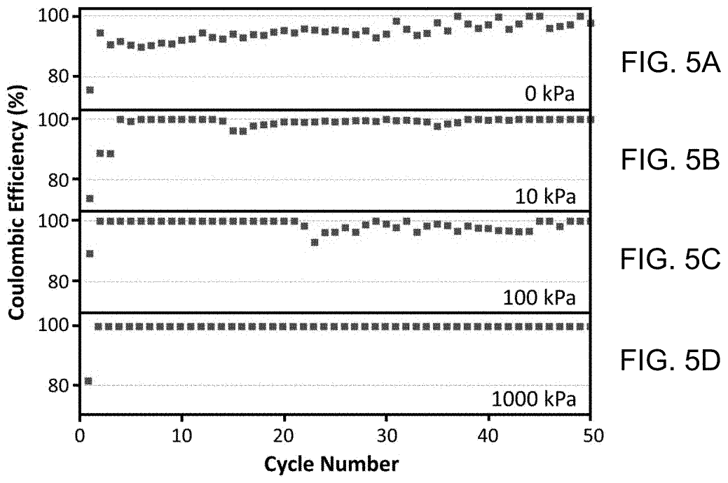

Coulombic efficiency plots are shown in FIGS. 5A-5D with pressure variations between 0 and 1000 kPa. There is a clear trend towards higher CE with increasing applied pressure. Most cells show low CE on the first cycle and then the CE increases with cycling. CE less than 100% on the first cycle is expected and is typically attributed to SEI formation. A cell with 100% CE means that the charge passed during deposition was exactly the same as that passed during stripping. Since SEI formation is generally not reversible, 100% CE indicates that there were no parasitic losses due to SEI formation. Thus, 100% CE also implies that all of the deposited lithium was accessible during stripping. However, 100% Coulombic efficiency could also indicate that the battery suffered from a partial or complete short circuit.

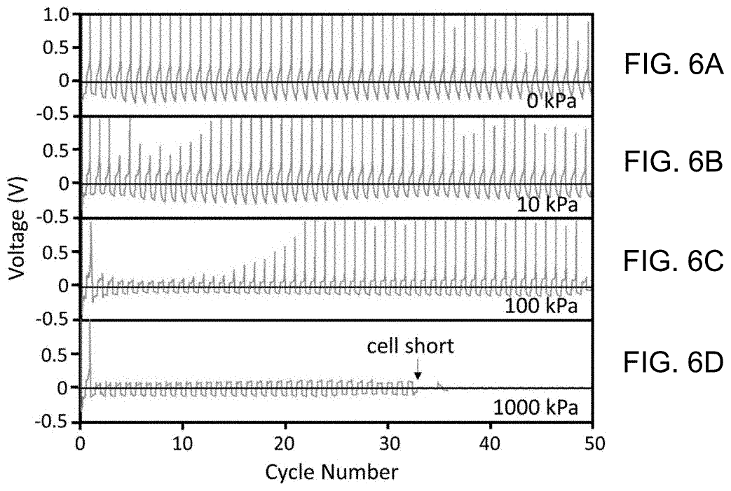

FIGS. 6A-6D show the voltage fluctuations for all 50 cycles during deposition and stripping. It is expected that the voltage during deposition is relatively flat because there is a large excess of lithium in the counter electrode, so there are no limitations to stripping the lithium from the counter electrode and depositing it on the working electrode. However, during stripping, a sudden voltage increase is expected when the accessible deposited lithium on the working electrode is completely stripped. This sudden voltage increase is expected to occur before the time limit due to parasitic losses such as SEI formation and the possibility of some lithium disconnecting from the current collector. The cells compressed at higher pressure exhibit sudden voltage increases less often. If no sudden voltage increase occurs, the stripping step terminates after 30 minutes, such that the charge passed during stripping on the working electrode equals that passed during deposition on the working electrode. Thus, sudden voltage increases at the end of the stripping cycle imply that the CE will be less than 100%. The absence of the voltage increase at the end of a stripping cycle implies that the CE is 100% for that cycle and that there were no parasitic losses (SEI formation) or disconnected lithium present. Clearly, cycles with no sudden increase in voltage at the end of stripping in FIG. 6D agree with the 100% CE measurements in FIG. 5D for cells with higher interfacial compression. Conversely, the absence of sudden voltage increases after the first cycle could indicate the presence of partial short circuits where some current is carried via a short circuit and some is carried electrochemically even in very early devices. The absence to sudden voltage increases upon the stripping step is more prevalent at higher pressure, suggesting that high pressure may exacerbate short circuits. In some cells, there is also evidence of catastrophic cell short circuits when high pressure is applied to the cell, characterized by a sudden drop in voltage (after about 33 cycles in this particular cell) at 1000 kPa.

### Cell Disassembly and Characterization

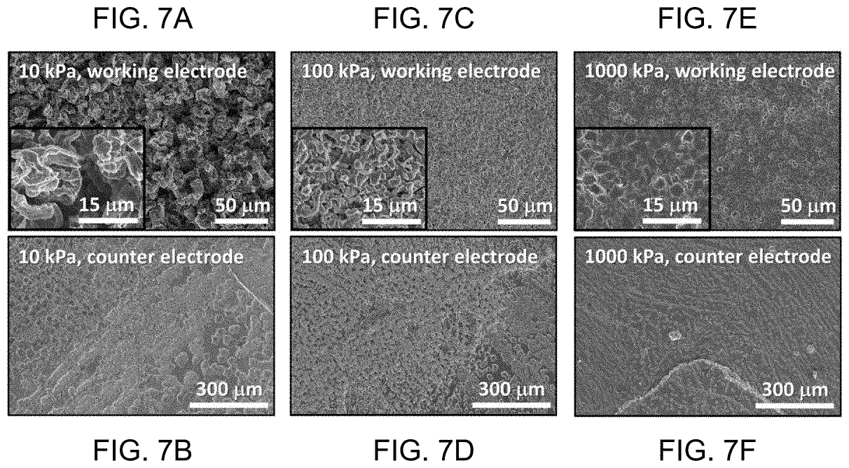

Some of the cells were disassembled for characterization. It is generally difficult to remove the working electrodes from cells cycled many times. However, it is generally easy to remove working and counter electrodes from cells cycled 0.5 times. SEM images of working electrodes cycled 0.5 times are shown in FIGS. 7A, 7C, and 7E at various magnifications. Higher magnification SEM images from working electrodes extracted from cells cycled 0.5 times are shown in the insets. It is clear that the morphology changes drastically with applied pressure. The deposits appear denser and are generally smaller with increased pressure. The deposits are also thinner in cells with higher applied pressure (not shown). The CE on the first cycle generally increases in cycled cells with increasing pressure, indicating that the initial deposition step results in more lithium and less SEI than at lower pressure. Thus, the only way to obtain thicker lithium deposits in cells compressed at lower pressure is if the deposits are much less dense than those compressed at higher pressure. SEM images of the counter electrodes are also shown in FIGS. 7B, 7D, and 7F. In general, the morphological features on the counter electrode also decrease with increasing applied pressure, though the morphology varies more significantly than for the working electrodes. This again, suggests denser morphological features for highly compressed cells.

The results presented in FIG. 4 to FIG. 7 were obtained from cells prepared with two layers of Celgard 2325 separator, which consists of a porous polyethylene layer sandwiched between polypropylene layers. While the global pressure can be precisely controlled with a feedback-controlled load frame, the local pressure on the lithium dictates how the local morphology evolves. Because separators are porous, their structure affects the local force distribution at the lithium metal surface. Therefore, the effects of compression on lithium morphology and electrochemical performance are dependent on the separator. A separator with uniformly distributed pores of nanoscale dimension allows more uniform force distribution at the lithium metal anode and will likely provide more uniform and dense morphology, higher CE, and less chance of dendritic Li growth. By the same logic, minimizing roughness in all cell components provides a more uniform force distribution and improved lithium electrodeposition. See X. Zhang et al., J. Electrochem. Soc. 166(15), A3639 (2019).

### Coin Cell Compression Design

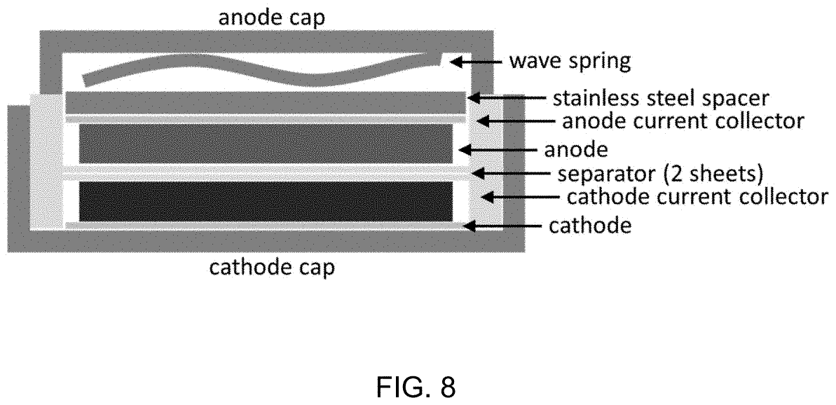

The electrode stack layers that make up a typical coin cell are shown in FIG. 8. The anode can be the counter electrode and the cathode can be the working electrode in this cell. Mild compression is generally applied to the electrode stack to ensure reasonable contact resistance between the cell caps and the anode and cathode. However, there is typically no quantification of the compression forced in coin cells despite the variations in procedures. For the purpose of controlling SEI formation, the compression can be achieved by a wave spring, Belleville washer, or one or more pieces of metal (e.g., nickel) foam. The spacer thickness, electrode thickness, lithium metal thickness, and spring or nickel foam thickness/properties can vary.

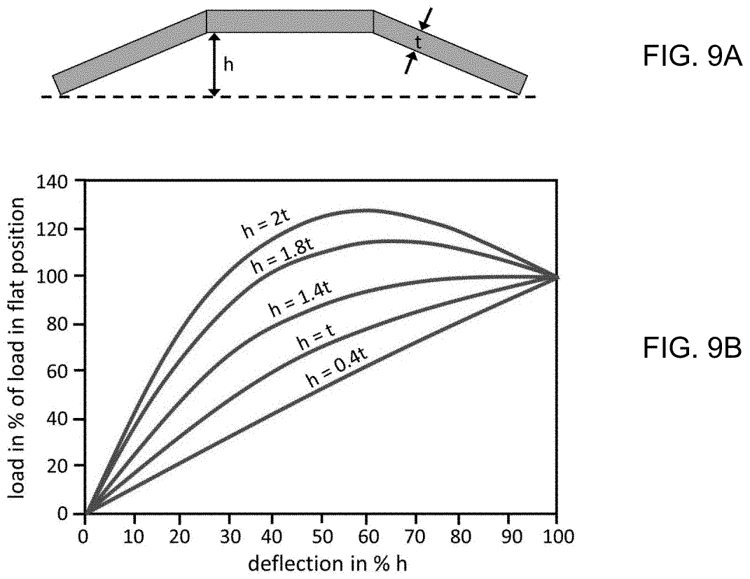

Because compression force drastically affects lithium plating and stripping during cycling and because force is likely to change during cycling and affect the performance for some materials, it is worthwhile to fabricate coin cells with varied and quantified forces. An interesting property of Belleville washers is that they can be designed such that the force is approximately constant over a range of deflection, unlike wave springs which monotonically increase in force with deflection. However, the Belleville washers commercially available for batteries are not designed to keep force constant. A schematic of the Belleville washer with key dimensions is shown in FIG. 9A. A diagram of the relationship between force and deflection for Belleville washers is shown in FIG. 9B. The key parameter that controls whether force stays approximately constant over a range of deflection is the height of the disc over the thickness of the disc. For approximately constant force with deflection, one requires h/t˜1.2-1.8. The force range that can be achieved with the washer varies with thickness, diameter, and height. An exemplary Belleville washer is 316 stainless steel, 15.5 mm outer diameter, 8.0 mm inner diameter, 0.38 mm thick, and 0.7 mm dish height.

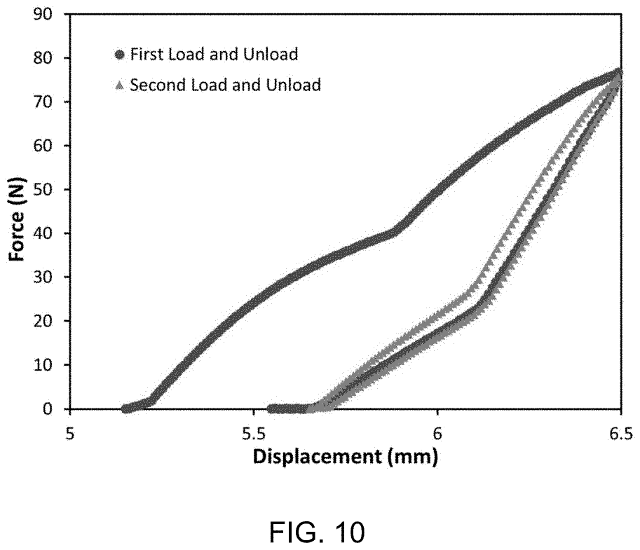

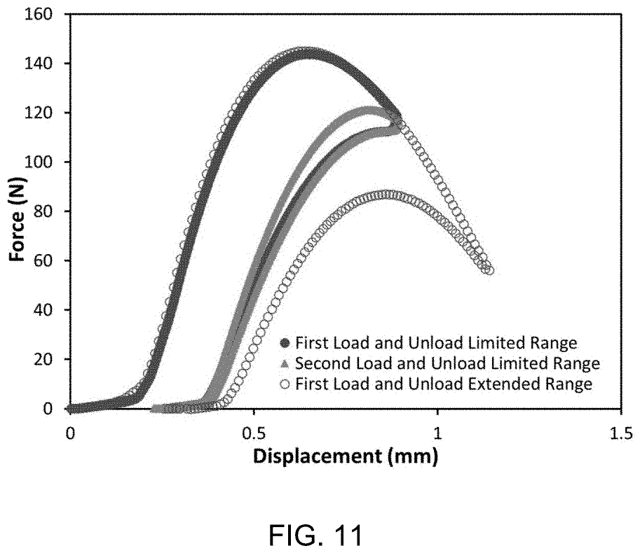

Force-displacement data for wave springs and Belleville washers typically used in 2032 coin cells are shown in FIG. 10 and FIG. 11, respectively. These experiments were performed by compressing springs in a load frame. The force-displacement relationship stabilizes after the first loading-unloading cycle and then the response is generally approximately constant in subsequent loading-unloading cycles, so only two cycles are shown. FIG. 10 shows that displacement increases with increasing force approximately linearly for wave springs, with two slightly different slope regimes. Conversely, FIG. 11 shows a more complicated relationship between force and displacement for Belleville washers. The Belleville washers shown here and typically used in coin cells have an h/t ratio ˜5. Clearly this is much too high to keep force constant with changes in displacement and custom Belleville washers need to be made to enable an h/t ˜1.2-1.8 to keep force approximately constant over a reasonable range of displacement.

Using the force-deflection data, the spring forces on an electrode stack of known thickness given a certain spring can be calculated. By measuring the height of the coin cell, it is possible to back out the deflection of the spring if all component thicknesses are known. Thus, force can be quantified. Furthermore, the force can be varied by stacking springs. Two springs stacked in parallel approximately doubles the force for the same deflection. Therefore, coin cells can be fabricated but with varied numbers of springs and spacers to vary the force on the stack. For example, by stacking 1-4 springs, the force can be varied over a wide range. Measurements were performed to determine the force-deflection relationships for representative Belleville washers (Table 1) and wave springs (Table 2).

TABLE 1
Measurements of the average spring constant and average
maximum force for force adjusting Belleville washers.

| | Average spring | Average max |
|---|---|---|
| | constant (N/mm) | force (N) |
| Single | 334.8 | 143 |
| Double stack | 645.0 | |
| Ratio | 1.9 | |

TABLE 2
Measurements of the average spring constant
and average maximum force for wave springs.

| | Average | Average | Average |
|---|---|---|---|
| | spring | spring | spring |
| | constant | constant | constant |
| | (from | (from | (from |
| | 0-.46 mm) | .46-.86 mm) | .86+ mm) |
| | (N/mm) | (N/mm) | (N/mm) |
| Single | 52.32 | 139.61 | 2706.71 |
| Double stack | 89.08 | 268.77 | 2214.08 |
| Ratio | 1.7 | 2.0 | 0.8 |

The present invention has been described as mechanical interfacial control of lithium metal anodes. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method for controlling solid-electrolyte interphase formation and subsequent lithium metal plating and stripping in a lithium battery having a lithium metal anode, comprising applying interfacial compression to the lithium metal anode during electrochemical cycling.

2. The method of claim 1, wherein the lithium battery comprises a pouch cell.

3. The method of claim 1, wherein the lithium battery comprises a coin cell.

4. The method of claim 1, wherein the interfacial compression comprises a contact pressure greater than 10 kPa.

5. The method of claim 4, wherein the interfacial compression comprises a contact pressure less than 1000 kPa.

6. A lithium coin cell battery comprising,
a lithium metal anode, and
a means for applying interfacial compression to the lithium metal anode during electrochemical cycling.

7. The coin cell battery of claim 6, wherein the compression means comprises a wave spring, Belleville washer, or metal foam.

8. The coin cell battery of claim 7, wherein the compression means comprises a Belleville spring and the height of the disc over the thickness of the disc, h/t, is approximately 1.2-1.8 to provide a constant force of interfacial compression.

9. The coin cell battery of claim 6, wherein the compression means comprises two or more Belleville springs that are stacked.
